(19) United States
(12) Patent Application Publication
(10) Pub. No.: US 2016/0289103 A1
(43) Pub. Date: Oct. 6, 2016

(54) TAILINGS-POLYMER MIXING OPTIMIZATION BY CONTROLLING THE DISCHARGE ENVIRONMENT

(71) Applicant: SYNCRUDE CANADA LTD. in trust for the owners of the Syncrude Project as such owners exist now and, Fort McMurray (CA)

(72) Inventors: JAMES LORENTZ, Fort McMurray (CA); BARRY BARA, Edmonton (CA); RANDY MIKULA, Edmonton (CA)

(21) Appl. No.: 14/673,632

(22) Filed: Mar. 30, 2015

(51) Int. Cl. C02F 1/54

(52) U.S. Cl. CPC C02F 1/54; C02F 2101/32

(57) ABSTRACT

A process for dewatering tailings is provided comprising providing a tailings feed having a solids content in the range of about 10 wt % to about 70 wt %; adding an effective amount of a polymeric flocculant to the tailings feed and, optionally, mixing the polymeric flocculant and tailings feed mixture in a mixer; transporting the tailings feed and polymeric flocculant mixture to a deposition area; and optimizing the overall mixing and therefore dewatering rate of the tailings feed and polymeric flocculant mixture by controlling the conditions used for discharging the mixture to a deposition area.

### FIELD OF THE INVENTION

The present invention relates to a process for dewatering tailings such as oil sands tailings. In particular, the present invention is directed to a process for optimizing the dewatering of polymeric flocculant-treated tailings by controlling the deposition or discharge conditions of polymeric flocculant-treated tailings in a deposition area.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of fine tailings composed of fine silts, clays, residual bitumen and water. Mineral fractions with a particle diameter less than 44 microns are referred to as “fines.” These fines are typically clay mineral suspensions, predominantly kaolinite and illite.

The fine tailings suspension is typically 85% water and 15% fine particles by mass. Dewatering of fine tailings occurs very slowly. When first discharged in ponds, the very low density material is referred to as thin fine tailings. After a few years when the fine tailings have reached a solids content of about 30-35%, they are sometimes referred to as mature fine tailings (MFT) which behave as a fluid-like colloidal material. The more general term used for tailings which behave as fluid-like colloidal suspension is fluid fine tailings or FFT. The fact that fluid fine tailings behave as a fluid and have very slow consolidation rates significantly limits options to reclaim tailings ponds. A challenge facing the industry remains the removal of water from the fluid fine tailings to strengthen the deposits, so that they can be reclaimed and no longer require containment.

One method used to dewater fluid fine tailings such as MFT is to treat the tailings with polymeric flocculants to form large flocs which will release the water more rapidly. However, optimizing dewatering of fluid fine tailings such as MFT is achieved only with ideal mixing of the tailings and flocculant, and the operating window for ideal mixing is often very narrow. The current state of the art attempts to achieve optimum mixing in a mixing vessel or in-line mixer located at some distance along a discharge pipe (see, for example, CA 2,789,678 and CA 2,678,818). Hence, the tailings and polymer mixture is typically optimally mixed at a mixer discharge or at the end of a pipe. Furthermore, the nature of the mixing at deposition is much different than in a mixer, in a pipe, or during discharge.

A tailings and polymer mixture that is optimally mixed after the mixer stage or at the end of pipe has the potential to be over-mixed upon discharge. There is then a reliance on a gentle transport and/or deposition of the flocculated tailings to maintain the optimum mixed condition after the tailings polymer mixture has been deposited for maximum dewatering. Often, this is very difficult to control.

There is a need in the industry for a method of ensuring that optimal mixing, and therefore dewatering, is still maintained when the tailings are finally discharged into the tailings disposal area.

### SUMMARY OF THE INVENTION

The present invention uses the discharge conditions as an integral and critical part of the total mixing protocol for mixing tailings with polymeric flocculant.

It was surprisingly discovered that the discharge conditions could be manipulated to produce optimally mixed tailings (e.g., MFT) and flocculant, thereby maximizing dewatering of the tailings. The mixing under discharge conditions can be controlled, for example, by adjusting the height of a vertical tailings discharge pipe, by adjusting the velocity of a tailings-flocculant mixture into a plunge pool, or by use of a weir box. Thus, the overall mixing of the polymer and tailings can be controlled by optimizing these discharge parameters.

Depending upon the extent of any upstream mixing, the discharge conditions are controlled to optimize the mixed condition of the finally deposited flocculant treated tailings. This optimization might provide either incremental mixing or the entirety of the mixing energy necessary to produce optimally flocculated and dewatering tailings. The current state of the art generally involves mixing in a static or dynamic mixer followed by pipeline transport or mixing in the pipeline itself. However, additional mixing may occur during deposition which can result in over-mixing, i.e., over-shearing of the formed flocs, which can result in poor dewatering of the tailings.

It was surprisingly discovered that the discharge conditions could be manipulated to produce an optimally mixed tailings (e.g., MFT) and flocculant, thereby maximizing dewatering of the tailings. The mixing under discharge conditions can be controlled, for example, by adjusting the height of a vertical tailings discharge pipe, by adjusting the velocity of a tailings-flocculant mixture into a plunge pool, or by adjusting the discharge distance into a weir box. Thus, the mixing of the polymer and tailings is controlled by optimizing these discharge parameters.

In one aspect, a process for dewatering tailings is provided, comprising:
providing a tailings feed having a solids content in the range of about 10 wt % to about 70 wt %;
adding an effective amount of a polymeric flocculant to the tailings feed and, optionally, mixing the polymeric flocculant and tailings feed mixture in a mixer or a pipeline;
transporting the tailings feed and polymeric flocculant mixture to a deposition area; and
optimizing the dewatering rate of the tailings feed and polymeric flocculant mixture by controlling the discharging conditions used for discharging the mixture to a deposition area.

In one embodiment, the discharging conditions are controlled by adjusting the height of a vertical tailings discharge pipe. In another embodiment, the discharging conditions are controlled by discharging the tailings feed and polymeric flocculant mixture into a plunge pool and adjusting the velocity of discharge into the plunge pool. In another embodiment, the flocculated tailings are discharged into an optimally designed weir box, for instance, by optimizing end of pipe to weir wall distance or weir box dimensions.

In one embodiment, the tailings feed and polymeric flocculant mixture is transported through a pipeline. In one embodiment, the flow of the tailings feed and polymeric flocculant mixture through a pipeline is laminar flow.

In one embodiment, a coagulant is also added to the tailings feed either prior to or after the addition of the polymeric flocculant.

In one embodiment, the tailings are oil sands tailings, such as fluid fine tailings, having a solids content in the range of about 10 wt % to about 45 wt %. In another embodiment, the tailings feed has a solids content in the range of about 30 wt % to about 45 wt %.

In one embodiment, the polymeric flocculant is a water soluble polymer having a moderate to high molecular weight and an intrinsic viscosity of at least 3 dl/g (measured in 1N NaCl at 25° C.).

Additional aspects and advantages of the present invention will be apparent in view of the description, which follows. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawing:

FIG. 1 is a graph showing yield stress (Pa), capillary suction time (sec), and torque (Nm), versus time, of an MFT sample which has been mixed with a polymeric flocculant in a dynamic mixer.

FIG. 2 is a schematic of one mixing protocol of present invention.

FIG. 3 is a photograph of a standpipe useful in discharging a polymeric flocculant and tailings mixture into a deposition site in one embodiment of the present invention.

### DETAILED DESCRIPTION OF EMBODIMENTS OF THE INVENTION

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present invention may be practised without these specific details.

The present invention relates generally to a process for dewatering tailings such as tailings that are derived from oil sands extraction operations. In general, a tailings feed is provided having a solids content in the range of about 10 wt % to about 70 wt % and an effective amount of a polymeric flocculant is added to the tailings feed and transported through a pipeline to a deposition area. The tailings and the polymeric flocculant are optionally mixed in a mixer such as a dynamic mixer or an in-line or static mixer or in a pipeline prior to being subjected to further mixing upon discharge. However, it is understood that all of the mixing energy necessary to form optimally dewatering tailings can solely occur at discharge.

Hence, the mixing and therefore dewatering rate of the polymeric flocculant and tailings is optimized by controlling the discharge conditions under which the polymeric flocculant and tailings mixture is placed in a deposition area. Thus, much, or perhaps all, of the mixing energy needed to form optimally dewatering flocs can actually be provided during the discharging of the tailings in the deposition area.

As used herein, the term “oil sands tailings” means tailings derived from oil sands extraction operations and containing a fines fraction. The term is meant to include fluid fine tailings (FFT) from tailings ponds and fine tailings from ongoing extraction operations (for example, thickener underflow or froth treatment tailings). The tailings are treated with a flocculant to aggregate the solids and aid in the consolidation and dewatering of the tailings.

As used herein, the term “flocculant” refers to a reagent which bridges particles into large agglomerates or flocs, resulting in more efficient settling and dewatering. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

In one embodiment, the flocculant comprises an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The preferred flocculant may be selected according to the tailings composition and process conditions.

The flocculant is generally supplied from a flocculant make up system for preparing, hydrating and dosing of the flocculant. Flocculant make-up systems are well known in the art, and typically include a polymer preparation skid, one or more storage tanks, and a dosing pump. The dosage of flocculant may be controlled by a metering pump. In one embodiment, the dosage of flocculant ranges from about 400 grams to about 1,500 grams per tonne of solids in the FFT. In one embodiment, the flocculant is in the form of a 0.4% solution.

In one embodiment, a coagulant is also added to the tailings feed. As used herein, the term “coagulant” refers to a reagent which neutralizes repulsive electrical charges surrounding particles to destabilize suspended solids and to cause the solids to agglomerate. Suitable coagulants include, but are not limited to, gypsum, lime, alum, polyacrylamide, or any combination thereof. In one embodiment, the coagulant comprises gypsum or lime.

It is important that the tailings and flocculant are properly mixed in order to form large, stable, rapidly dewatering flocs. It was discovered that, the discharge conditions can be controlled to add an optimized amount of incremental mixing or to provide the entirety of the mixing energy in order to optimize the dewatering rate of the tailings-flocculant mixture. The current state of the art, which involves tailings and flocculant mixing prior to pipeline transport or mixing in the pipe, is sensitive to whether the flow conditions in the pipe are laminar or turbulent, and demands deposition conditions that do not create a less than optimum mixture.

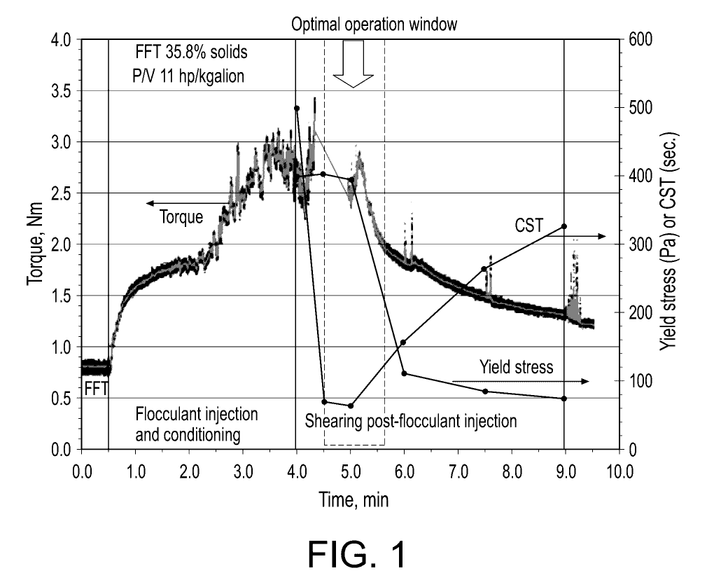

FIG. 1 is a graph showing the effects of mixing time in a dynamic mixer on a mature fine tailings (MFT) sample having a solids content of 35.8 wt % and an anionic polyacrylamide polymeric flocculant. In this example, samples of MFT were taken from a dynamic mixer at various time periods (in minutes) post flocculant polymer addition. The torque, which is a measure of the turning force on the impeller, was plotted against time (in minutes) over the entire period of the test. The yield stress (Pa) and capillary suction time (CST in seconds) were also measured at various time intervals after about 3.5 minutes of mixing of polymer and MFT. CST is used to determine how quickly water can be filtered from a flocculated sample. A high CST may indicate both under-mixing of tailings and flocculant or over-mixing of tailings and flocculant.

For optimally flocculated tailings, it is desirable that the CST be low and that the yield stress be relatively high, indicating good dewatering and good floc formation, respectively. It can be seen in FIG. 1 that there is a conditioning period (i.e., mixing period) required for good floc formation. During this conditioning period, yield stress is low (indicated by low torque) and CST is high (indicating poor dewatering). It can be seen than maximum yield stress is obtained at about 4.5 minutes post flocculant addition and, at this time, CST begins to drop, indicating good dewatering conditions. However, if mixing continues past about 5.5 minutes post-flocculation, the yield stress begins to decline and the CST begins to rise. This indicates over-shearing, where the large flocs are broken down resulting in poor dewatering. Thus, the optimal operation window is likely between about 4.0 to about 5.1 minutes post flocculant polymer addition. Hence, the optimal operating window for mixing is quite narrow and it occurs as the yield stress is changing over a wide range.

Thus, FIG. 1 clearly shows that when mixing time increases beyond the optimal operating window, yield stress of the sample is reduced and the CST increases. The yield stress change with mixing time could easily represent a transition from laminar to turbulent flow, complicating the ability to control mixing in a pipeline after a dynamic or static mixer. Thus, it was discovered that having less initial mixing of flocculant and tailings, e.g., upstream of transport, is more desirable, with additional mixing occurring at the downstream end of transport, i.e., at the discharge end of the flocculation process.

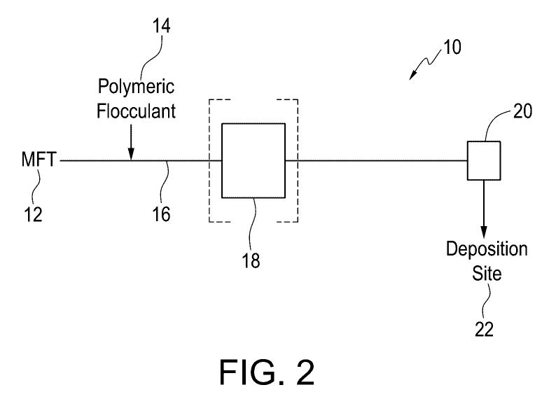

It was discovered that by utilizing pipe discharging mixing conditions to add mixing downstream, the tailings (e.g., MFT) and polymer mixture can be optimized for maximum water release. Rather than attempting to optimize mixing in the process and piping, mixing is optimized at the discharge point. FIG. 2 is a schematic showing one embodiment of the present invention. MFT 12 is transported through a pipe 16 where polymeric flocculant is injected therein by means of an injection system such as a T-inlet. In this embodiment, the mixing protocol 10 may optionally comprise a mixer 18, such as a dynamic mixer, which mixer 18 mixing conditions can be controlled to ensure that only preliminary mixing of the MFT 12 and polymeric flocculant 14 is obtained, i.e., where the CST is still high and the yield stress is still low. Thus, the mixture is still in the conditioning zone as shown in FIG. 1. The polymeric flocculant and MFT mixture is then transported via pipeline 16 to discharge 20, where additional mixing is provided upon discharge of the polymeric flocculant/MFT mixture into deposition site 22. In one embodiment, it may be desirable to maintain laminar flow conditions in the pipe 16.

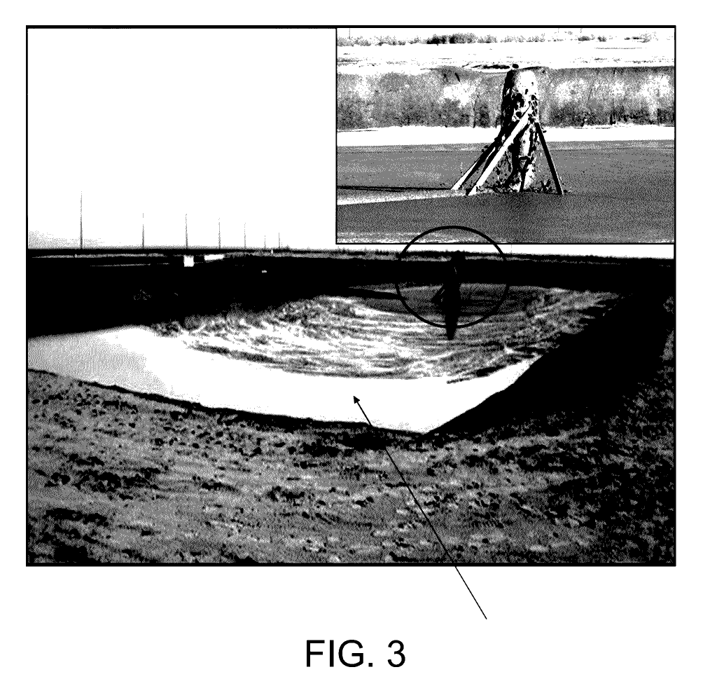

In one embodiment, optimized mixing at the discharge can be achieved with a vertical drop from a standpipe, as shown in FIG. 3. In another embodiment, the flocculated tailings can be discharged into a plunge pool. In another embodiment, the flocculated tailings can be discharged into a weir box. In one embodiment, the slope of the deposit that the flocculated material will run down can be controlled to control mixing.

### EXAMPLE 1

In this example, the tailings used are mature fine tailings (MFT) which generally have a solids content of about 35 wt % and a fines content of about 90 wt %. The polymeric flocculant used in this example is an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The polymer dosage ranged from about 750-850 g/tonne dry weight of tailings.

In this example, the MFT and polymeric flocculant mixture was under-mixed pre-discharge and then discharged into a pit by means of a standpipe as shown in FIG. 3. A capillary suction test (CST) was performed on the tailings at the top of the standpipe, immediately prior to discharge. Samples collected at the discharge of the standpipe showed very high CST values (i.e., greater than about 700 sec), indicating under-mixing and that a very poor degree of dewatering would be expected. However, further mixing was added as a result of the mixture being discharged from a considerable height into the pit. Additional mixing is defined by the discharge height of the standpipe; in this instance, the standpipe was 3 meters in height. Thus, the polymeric flocculant/MFT mixture was falling into the deposition site as a velocity of about 7.7 meters/sec. It can be seen in FIG. 3 that the deposit created by this standpipe discharge is showing a significant degree of dewatering, as indicated by the arrow in FIG. 3. A significant amount of water is released from the MFT and is collecting at the end of the pit.

Thus, the mixing created by the standpipe was determined by the vertical discharge height. The mixing conditions might also be adjusted by modifying the discharge velocity. Mixing might further be optimized by control of the discharge beach slope, or by a combination of all of these factors. Thus, the use of discharge conditions to control mixing and optimizing dewatering rate is an important improvement relative to the current state of the art.

We claim:

1. A process for dewatering tailings, comprising:
providing a tailings feed having a solids content in the range of about 10 wt % to about 70 wt %;
adding an effective amount of a polymeric flocculant to the tailings feed and, optionally, mixing the polymeric flocculant and tailings feed mixture in a mixer or pipeline;
transporting the tailings feed and polymeric flocculant mixture to a deposition area; and
optimizing the dewatering rate of the tailings feed and polymeric flocculant mixture by controlling the discharging conditions used for discharging the mixture to the deposition area.

2. The process as claimed in claim 1, wherein the discharging conditions are controlled by adjusting the height of a vertical tailings discharge pipe.

3. The process as claimed in claim 1, wherein the discharging conditions are controlled by discharging the flocculated tailings into a plunge pool and adjusting the velocity of discharge into the plunge pool.

4. The process as claimed in claim 1, wherein the flocculated tailings are discharged into a weir box.

5. The process as claimed in claim 1, further comprising adding an effective amount of a coagulant to the tailings feed either before or after adding the polymeric flocculant.

6. The process as claimed in claim 1, wherein the tailings feed is oil sands tailings.

7. The process as claimed in claim 1, wherein the tailings feed is fluid fine tailings having a solids content in the range of about 10 wt % to about 45 wt %.

8. The process as claimed in claim 1, wherein the tailings feed has a solids content in the range of about 30 wt % to about 45 wt %.

9. The process as claimed in claim 1, wherein the polymeric flocculant is a water soluble polymer having a moderate to high molecular weight and an intrinsic viscosity of at least 3 dl/g (measured in 1N NaCl at 25° C.).

10. The process as claimed in claim 1, wherein the tailings feed and polymeric flocculant mixture is transported through a pipeline.

11. The process as claimed in claim 10, wherein the flow of the tailings feed and polymeric flocculant mixture through a pipeline is laminar flow.

12. The process as claimed in claim 1, wherein the polymeric flocculant and tailings are mixed in a dynamic mixer prior to transporting the mixture to the deposition area.

13. The process as claimed in claim 12, wherein the mixing time in the dynamic mixer is less than the time required for the CST of the mixture to decline and the yield stress of the mixture to increase.
